(19) United States
(12) Patent Application Publication
(10) Pub. No.: US 2015/0178420 A1
(43) Pub. Date: Jun. 25, 2015

(54) INFORMATION PROCESSING APPARATUS, INFORMATION PROCESSING SYSTEM, METHOD OF PROCESSING INFORMATION, AND PROGRAM

(71) Applicant: Manami KIKUCHI, Kanagawa (JP)

(72) Inventor: Manami KIKUCHI, Kanagawa (JP)

(73) Assignee: RICOH COMPANY, LTD., Tokyo (JP)

(21) Appl. No.: 14/574,725

(22) Filed: Dec. 18, 2014

(30) Foreign Application Priority Data
Dec. 25, 2013 (JP) 2013-266435

(51) Int. Cl. G06F 17/50

(52) U.S. Cl. CPC G06F 17/5009

(57) ABSTRACT

An information processing apparatus includes a memory unit that stores information of each of machine bodies of apparatuses or each of machine types of the apparatuses in association with identification information of each of the machine bodies or each of the machine types; a receipt unit that receives a designation of the identification information of the machine body, which is a target of emulation, or the machine type, which is the target of the emulation; and an imitation unit that imitates an operation of a first apparatus among the apparatuses based on the information stored in the memory unit and corresponding to the identification information, of which designation is received by the receipt unit, when a request is received from an application program corresponding to the first apparatus.

### BACKGROUND OF THE INVENTION

1. Field of the Invention

The present invention relates to an information processing apparatus, an information processing system, a method of processing information, and a program.

2. Description of the Related Art

There is an image forming apparatus such as a multifunction peripheral, which has an application platform and can install an application program (hereinafter, an “application”) using an Application Program Interface (API) provided by the application platform. By releasing this API, it becomes possible to develop the application by not only a company manufacturing the image forming apparatus but also a third vendor other than the company.

An operation of an application under development is preferably checked by using the image forming apparatus. However, it is not economical to prepare an image forming apparatus for each developer. Further, it is not efficient that multiple developers use one image forming apparatus. Therefore, there is used software (hereinafter, an “emulator”) for emulating or simulating (hereinafter, referred to as “emulating”) operations of the hardware or the application platform of the image forming apparatus. For example, by installing the emulator on a personal computer (PC) or the like of each developer, each developer can effectively check operations of the application under development.

### SUMMARY OF THE INVENTION

The present invention is provided in consideration of the above points and it is a general object of at least one embodiment of the present invention to substantialize the emulation corresponding to a machine body or an machine type.

One aspect of the embodiments of the present invention may be to provide an information processing apparatus including a memory unit that stores information of each of machine bodies of apparatuses or each of machine types of the apparatuses in association with identification information of each of the machine bodies or each of the machine types; a receipt unit that receives a designation of the identification information of the machine body, which is a target of emulation, or the machine type, which is the target of the emulation; and an imitation unit that imitates an operation of a first apparatus among the apparatuses based on the information stored in the memory unit and corresponding to the identification information, of which designation is received by the receipt unit, when a request is received from an application program corresponding to the first apparatus.

Additional objects and advantages of the embodiments will be set forth in part in the description which follows, and in part will be clear from the description, or may be learned by practice of the invention. Objects and advantages of the invention will be realized and attained by means of the elements and combinations particularly pointed out in the appended claims.

It is to be understood that both the foregoing general description and the following detailed description are exemplary and explanatory only and are not restrictive of the invention as claimed.

### BRIEF DESCRIPTION OF THE DRAWINGS

FIG. 1 illustrates an exemplary hardware structure of an information processing apparatus of an embodiment of the present invention.

FIG. 2 illustrates an exemplary functional structure of the information processing apparatus of the embodiment of the present invention.

FIG. 3 is a flowchart illustrating an exemplary procedure performed by the emulation unit.

FIG. 4 is an exemplary display of a machine number input screen.

FIG. 5 illustrates an exemplary structure of specification information corresponding to one machine number.

FIG. 6 is a sequence chart for explaining an exemplary procedure of an initialization process.

FIG. 7 is the sequence chart for explaining the exemplary procedure of the initialization process.

FIG. 8 is the sequence chart for explaining the exemplary procedure of the initialization process.

FIG. 9 is a sequence chart for explaining an exemplary procedure of a job execution process.

FIG. 10 is a flowchart for explaining an exemplary procedure performed by a service administration unit when a copy job is executed.

### DETAILED DESCRIPTION OF THE PREFERRED EMBODIMENTS

In the above example, the image forming apparatus has a different function or the like for each machine body of each machine type. For example, the print job accepts a different setup item or a different setup value for the same setup item for each machine type.

However, differences of the machine bodies and the machine types are smoothed (standardized) in the above-described emulator. Therefore, it is difficult to check the operation of the application inherent in a certain machine body or machine type.

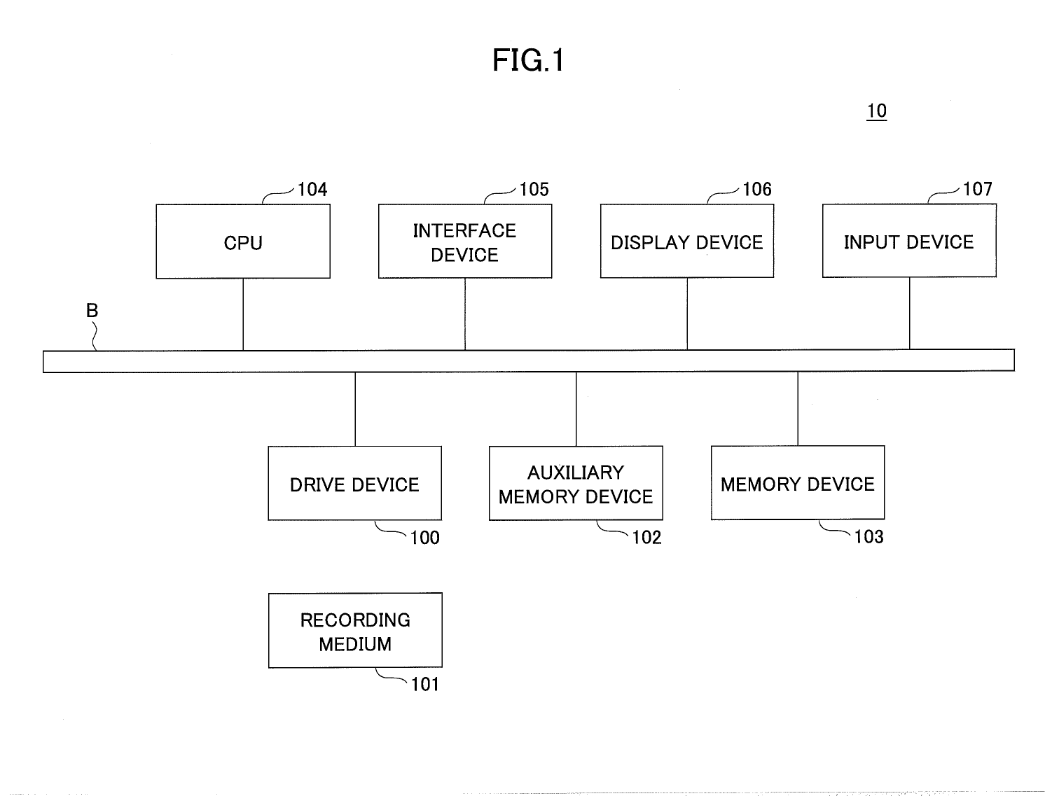

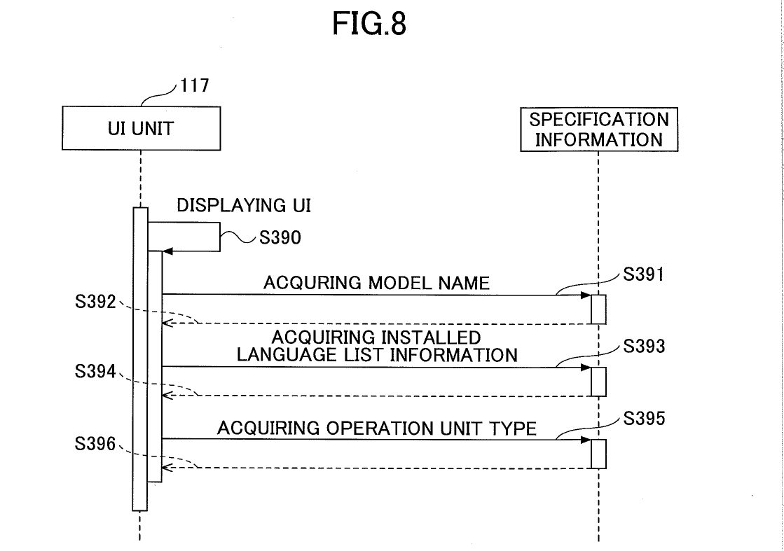

A description is given below, with reference to the FIG. 1 through FIG. 10 of embodiments of the present invention. Where the same reference symbols are attached to the same parts, repeated description of the parts is omitted.

Reference symbols typically designate as follows:
10: information processing apparatus;
11: emulation unit;
12: application;
100: drive device;
101: recording medium;
102: auxiliary memory device;
103: memory device;
104: CPU;
105: interface device;
106: display device;
107: input device;
111: request administration unit;
112: job administration unit;
113: service administration unit;
114: system administration unit;
115: state administration unit;
116: state change unit;
117: UI unit;
118: setup receipt unit;
119: specification information memory unit; and
B: bus.

FIG. 1 illustrates an exemplary hardware structure of an information processing apparatus of an embodiment of the present invention. The information processing apparatus 10 illustrated in FIG. 1 includes a drive device 100, an auxiliary memory device 102, a memory device 103, a CPU 104, and an interface device 105, a display device 106, an input device 107, or the like, which are mutually connected by a bus B.

A program substantializing processes in the information processing apparatus 10 is supplied by a recording medium 101 such as a CD-ROM. When the recording medium 101 having the program recorded on it is set into the drive device 100, the program is installed on the auxiliary memory device 102 through the drive device 100 from the recording medium 101. However, the program may not always be installed from the recording medium 101 and may be downloaded from another computer through the network. The auxiliary memory device 102 stores necessary files, data, and so on in addition to the installed program.

The memory device 103 reads out the program from the auxiliary memory device 102 when the program is instructed to be invoked and stores the read program into the memory device 103. The CPU 104 substantializes a function related to the information processing apparatus 10 in conformity with the program stored in the memory device 103. The interface device 105 is used as an interface for connecting to the network. The display device 106 displays a Graphical User Interface (GUI) or the like generated by the program. The input device 107 is configured to include a keyboard, a mouse or the like, and used to input various operation instructions.

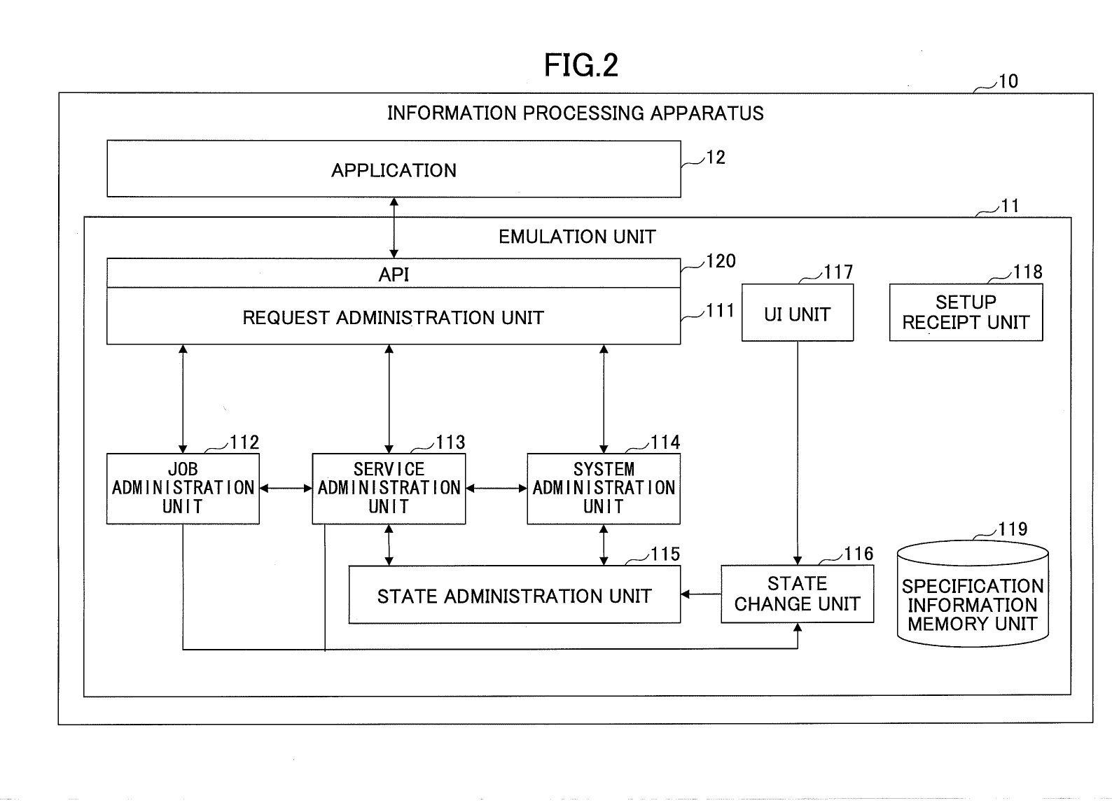

The information processing apparatus 10 may be a computer system may be a group including at least one structure illustrated in FIG. 1 or 2. The information processing apparatus 10 itself may not be a personal computer (PC) directly used by a user. For example, the information processing apparatus 10 may provide its function to the PC used by the user through an application service provider (ASP) or a web environment. In this case, the PC or the like used by the user may have, for example, a web browser.

FIG. 2 illustrates an exemplary functional structure of the information processing apparatus of the embodiment of the present invention. Referring to FIG. 2, the information processing apparatus 10 includes an emulation unit 11. At least one application 12 is installed on the information processing apparatus 10. The application 12 is an application program operable in an application platform included in an image forming apparatus (hereinafter, a “target apparatus”), for which the emulation unit 11 emulates. Said differently, the application 12 installed on the information processing apparatus 10 is developed in conformity with the target apparatus and is to be operated in the target apparatus. Said differently, the emulation unit 11 emulates (imitates) an operation of the application platform of the target apparatus, hardware of the target apparatus, or the like. Therefore, the emulation unit 11 can provide an operation environment similar to that in the target apparatus to the application 12. The emulation unit 11 is substantialized by the process caused by a program installed on the information processing apparatus 10 to be performed by the CPU 104. Within the embodiment, emulating or imitating includes a meaning of simulating.

Referring to FIG. 2, the emulation unit 11 includes a request administration unit 111, a job administration unit 112, a service administration unit 113, a system administration unit 114, a state administration unit 115, a state change unit 116, a UI unit 117, a setup receipt unit 118, or the like.

The request administration unit 111 includes an API 120 which is a part or all of an application program interface (API) provided in an application platform of the target apparatus and receives a request from the application through the API 120. The API 120 may be a function, a method, or a WebAPI. Here, the WebAPI is an API using a hypertext transfer protocol (HTTP) communication. However, other communication protocols other than the HTTP may be used.

The job administration unit 112 imitates an administration of the job in the target apparatus. The job administration unit 112 includes a module administrating the job for each job type. For example, when a copy job, a scan job, a FAX communication job, a print job, or the like can be performed, the job administration unit 112 includes a module for each of the copy job, the scan job, the FAX communication job, and the print job.

The service administration unit 113 imitates a control mechanism of hardware (an engine portion) of the target apparatus, which is used in conformity with the execution of the job. The control mechanism may be, for example, a driver program corresponding to, for example, the hardware. The service administration unit 113 issues an event related to a change of the state of the hardware of the target apparatus. This change of the state includes out of toner, an occurrence of jam, a start or end of scan, a start or end of print, or the like.

The system administration unit 114 imitates the administration of the state of the software of the target apparatus, which changes regardless of the job execution. An example of this state is a login state of the user, an energy-saving state, or the like. The system administration unit 114 issues an event related to this change of state.

The state administration unit 115 imitates the administration of the state of the hardware of the target apparatus. This state of the hardware of the target apparatus includes, for example, a state of jam, out of toner, or out of paper. The state administration unit 115 reports an event indicative of the change to the service administration unit 113, the system administration unit 114, and so on, in response to the occurrence of the change of the state of the emulation unit 11. The event is information related to an occurring event during the imitation of the operation of the target apparatus by the emulation unit 11 or information indicative of the occurrence of the occurring event.

The state change unit 116 forcibly changes the state of the emulation unit 11 at a timing designated by the user. For example, the state change unit 116 forcibly causes the toner outage of or the jam to occur. Further, the state change unit 116 can forcibly set the number of papers in an imaginary paper feeding tray or forcibly set the information of the login user. A state change request received by the state change unit 116 is reported to the state administration unit 115. The state administration unit 115 changes the state of the emulation unit 11 and reports an event indicative of the change to the service administration unit 113, the system administration unit 114, and so on, in response to this state change request. Therefore, the emulation unit 11 can imitate the process performed by the target apparatus in the state changed by the state change unit 116.

The UI unit 117 provides a user interface for operating the emulation unit 11. For example, the UI unit 117 causes a screen to be displayed on the display device 106 and receives an input of a change instruction of the state of the emulation unit 11 through the screen. The UI unit 117 reports an event occurring in the emulation unit 11 to the user through the screen.

The setup receipt unit 118 receives an input of setup information to the emulation unit 11 from the user. For example, the setup receipt unit 118 receives an input of identification information of the image forming apparatus (namely, the target apparatus) to be emulate or an input of identification information of a model (the machine type) of the target apparatus.

A quick real-time property is required for the job administration unit 112, the service administration unit 113, and the system administration unit 114 in the target apparatus. Exchanges of the events among these units may be directly performed.

The emulation unit 11 uses the specification information memory unit 119. The specification information memory unit 119 can be substantialized by using the auxiliary memory device 102. Alternatively, the specification information memory unit 119 may be substantialized by using a memory device connected to the information processing apparatus 10 through a network.

The specification information memory unit 119 stores information for each machine body in association with each identification information (hereinafter, “machine number”) of at least one specific image forming apparatus (namely, the target apparatus). The machine number is an example of the identification information for each machine body of the image forming apparatus. Exemplary information for each machine body relates to the performance or specifications of the image forming apparatus. Hereinafter, the information stored by the specification information memory unit 119 is called “specification information”. The specification information may include, for example, information indicative of the function provided with the image forming apparatus, information indicative of a hardware resource, a software resource, information indicative of a setup item (parameter) to be set, and so on. The specification information memory unit 119 may store specification information of the image forming apparatus belonging to a model in association with identification information (hereinafter, a “model name”) of the model instead of the specific image forming apparatus. The emulation unit 11 changes the process of the emulation in response to the specification information.

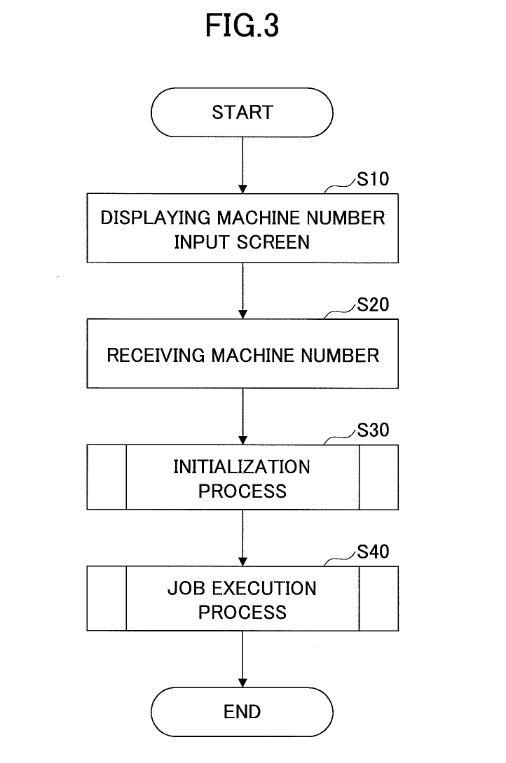

Hereinafter, the procedure performed by the information processing system 10 is described. FIG. 3 is a flowchart illustrating an exemplary process performed by the emulation unit. In the procedure of FIG. 3, a start-up instruction for starting up, for example, the emulation unit 11 is input and executed.

In step S10, the setup receipt unit 118 causes a machine number input screen to be displayed on the display device 106.

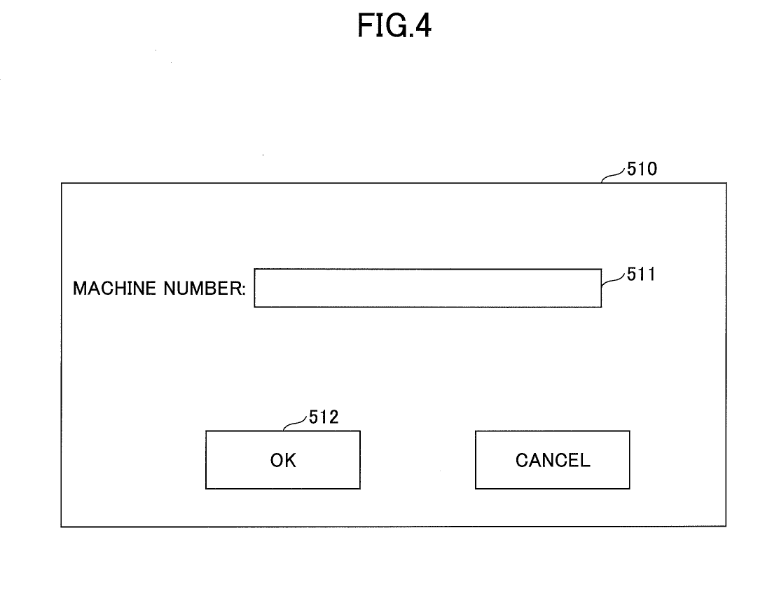

FIG. 4 is an exemplary display of a machine number input screen. Referring to FIG. 4, the machine number input screen 510 includes a machine number input area 511. The user inputs the machine number of the image forming apparatus to be emulated to the machine number input area 511. Alternatively, the machine number input area 511 may be a list box displaying a view (a compendium) of the machine numbers, which are included in each specification information stored in the specification information memory unit 119. In this case, the user can select a desired machine number from the view displayed in the list box.

In a case where the specification information is stored in association with the model name in the specification information memory unit 119, the model name may be input in the machine number input area 511.

When the machine number is input in the machine number input area 511 and an OK button 512 is pushed (step S20), the emulation unit 11 performs an initialization process (step S30). In the initialization process, the specification information (hereinafter, a “target specification information”) associated with the machine number input in the machine number input screen 510 is read from the specification information memory unit 119. The machine number (hereinafter, a target “machine number”) input in the machine number input area 511 in the memory device 103 so as to be referred to by the service administration unit 113, the job administration unit 112, or the like.

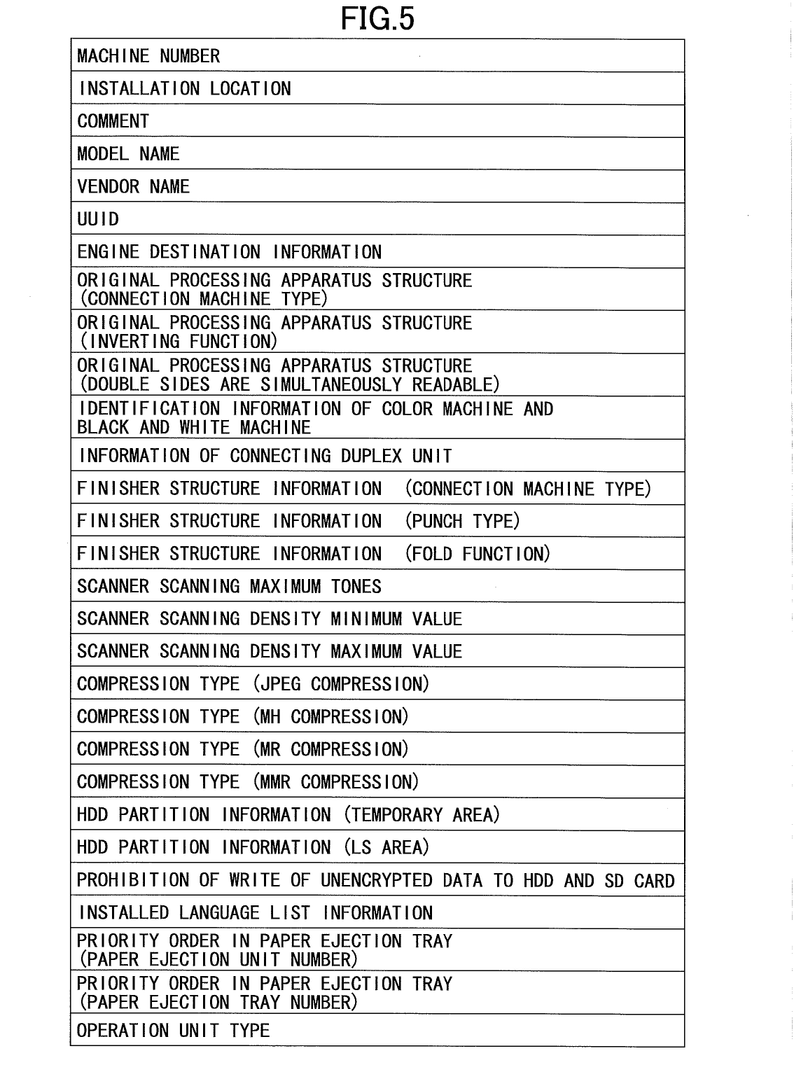

FIG. 5 illustrates an exemplary structure of specification information corresponding to one machine number. In FIG. 5, a view of items forming the specification information is displayed. A meaning of the items and a detailed initialization process are described later. The structure of the specification information is not limited to that illustrated in FIG. 5. An item which is not illustrated may be added, or the item which is illustrated may be deleted.

After completing the initialization process, the emulation unit 11 is in a steady state. The steady state is a state where an input from the application 12, the user, or the like is waited for. The input from the application 12 corresponds to a call of the API 120 by the application 12.

When an execution request of a job is received in the steady state, the emulation unit 11 emulates an operation of the image forming apparatus (i.e., the target apparatus) corresponding to the machine number and execute the requested job in a pseudo of virtual manner (step S40). The “pseudo of virtual manner” is a state where the job is not actually executed but an operation is performed as if the job is executed to a requester (for example, the application) of the job.

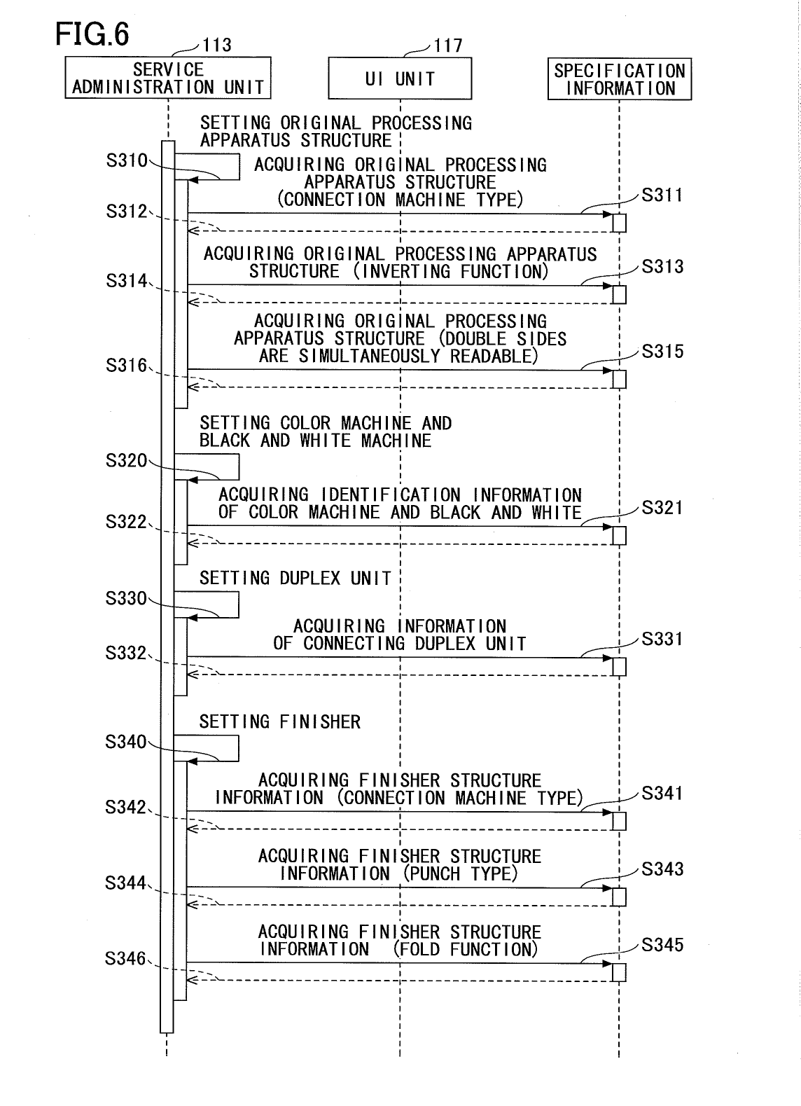

Next, a detailed description of the step S30 will be given. FIGS. 6, 7, and 8 illustrate a sequence chart for explaining an exemplary procedure of an initialization process.

In step S310 of FIG. 6, the service administration unit 113 sets an original processing apparatus structure. The original processing apparatus may be a scanner of the image forming apparatus. In setting the original processing apparatus structure, values of the items of the target specification information, namely, the original processing apparatus (connection machine type), the original processing apparatus structure (inverting function), and the original processing apparatus (double sides are simultaneously readable) are acquired from the specification information memory unit 119 and stored in the memory device 103 (steps S311 to S316).

The original processing apparatus structure (connection machine type) may be a machine type of a scanner provided with the target apparatus. The original processing apparatus structure (inverting function) may be whether a function of inverting the original in the scanner or not. The original processing apparatus structure (double sides are simultaneously readable) may be whether the double sides of the original can be simultaneously readable in the scanner or not.

Subsequently, the service administration unit 113 performs a setup of a color machine and black and white machine (step S320). In the setup process of the color machine and the black and white machine, a value of identification information of the color machine and the black and white machine is acquired from the specification information memory unit 119 and stored in the memory device 103 (steps S321 and S322). The identification information of the color machine and the black and white machine is information indicative of whether the target apparatus is the color machine or the black and white machine. The color machine is an apparatus capable of scanning in color or printing in color.

Subsequently, the service administration unit 113 performs a setup of a duplex unit (step S330). In the setup process of the duplex unit, a value of information of connecting the duplex unit is acquired from the specification information memory unit 119 and stored in the memory device 103 (steps S331 and S332). The information of connecting the duplex unit relates to the duplex unit connected to the target apparatus. The duplex unit is hardware for reading both surfaces of the original.

Subsequently, the service administration unit 113 performs a setup of a finisher (step S340). In the setup process of the finisher, values of items of target specification information, namely, finisher structure information (connection machine type), finisher structure information (punch type), and finisher structure information (fold function), are acquired from the specification information memory unit 119 and stored in the memory device 103 (steps S341 to S346). The finisher structure information (connection machine type) is the machine type of the finisher connected to the target apparatus. The finisher is hardware performing a post process such as punching or folding to an output paper. The finisher structure information (punch type) indicates a type of punching which can be performed by the finisher connected to the target apparatus. The finisher structure information (fold function) indicates whether a fold function exists in the finisher connected to the target apparatus or not.

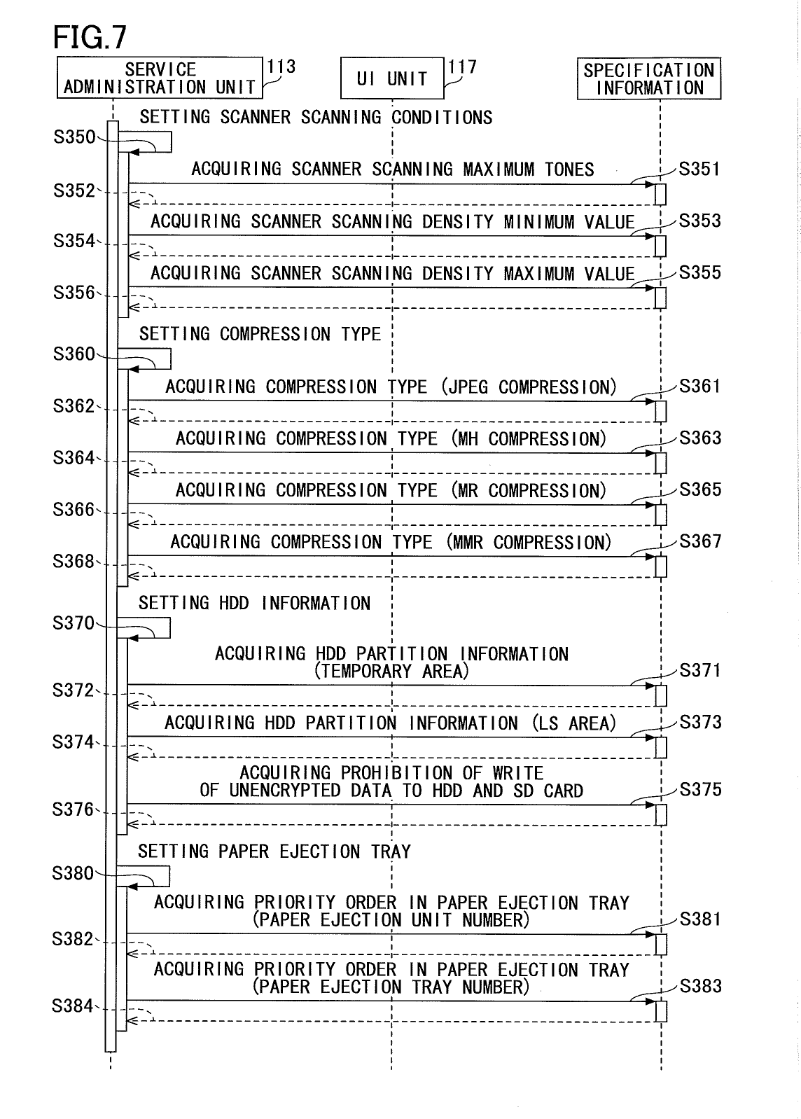

Subsequently, the service administration unit 113 performs a setup process of scanner scanning conditions (step S350 of FIG. 7). In the setup process of the scanner scanning conditions, values of items of the target specification information, namely, scanner scanning maximum tones, a scanner scanning density minimum value, and a scanner scanning density maximum value, are acquired from the specification information memory unit 119 and stored in the memory device 103 (steps S351 to S356). The scanner scanning density maximum value is the maximum value of a density obtainable at a time of scanning by the scanner of the target apparatus. The scanner scanning density minimum value and the scanner scanning density maximum value are the maximum value and the minimum valve of a scanning density obtainable at a time of scanning by the scanner of the target apparatus.

Subsequently, the service administration unit 113 performs a setup of a compression type (step S360). In the setup process of the compression type, values of items of the target specification information, namely, a compression type (JPEG compression), a compression type (MH compression), a compression type (MR compression), and a compression type (MMR compression), are acquired from the specification information memory unit 119 and stored in the memory device 103 (steps S361 to S368). Each of these items indicates whether the compression type indicated inside the parenthesis, namely, JPEG compression, MH compression, MR compression, or MMR compression is obtainable. The compression type indicates a kind of the compression process performed for the scanned image data.

Subsequently, the service administration unit 113 performs a setup of HDD information (step S370). In the setup process of the compression type, values of items of the target specification information, namely, HDD partition information (temporary area), HDD partition information (LS area), and prohibition of write of unencrypted data to HDD and SD card, are acquired from the specification information memory unit 119 and stored in the memory device 103 (steps S371 to S376). The HDD partition information (temporary area) and the HDD partition information (LS area) are views of the identification information of the application 12, which can use areas called the temporary area or the LS area of the HDD of the target apparatus. In the expression of the LS area, the “LS” stands for local storage. The temporary area is an area where temporary information is stored. The prohibition of write of unencrypted data to HDD and SD card is information indicative of whether the write of the unencrypted data to the HDD provided in the target apparatus or the SD card installed in the target apparatus is prohibited or not.

Subsequently, the service administration unit 113 performs a setup of a paper ejection tray (step S380). In the setup process of the paper ejection tray, values of items of the target specification information, namely, a priority order in paper ejection tray (paper ejection unit number) and a priority order in paper ejection tray (paper ejection tray number), are acquired from the specification information memory unit 119 and stored in the memory device 103 (steps S381 to S384). The priority order in paper ejection tray (paper ejection unit number) indicates a priority order of paper ejection destinations for each paper ejection unit in the target apparatus. The paper ejection unit may be a group of paper ejection trays of the body of the target apparatus, a group of paper ejection trays of the finisher connected to the target apparatus, or the like. Alternatively, a group of virtual paper ejection trays such as a mail box substantialized by a memory device may be included in the paper ejection unit. The priority order in paper ejection tray (paper ejection tray number) indicates a priority order of paper ejection destinations for each paper ejection tray in the target apparatus.

Subsequently, the UI unit 117 performs a display process of displaying a UI (an operation screen) for operating the emulation unit 11 (step S390). In the display process of the UI, values of items of the target specification information, namely, a model name, installed language list information, and an operation unit type, are acquired from the specification information memory unit 119 and stored in the memory device 103. The model name is the name of the model of the target apparatus. The installed language list information is list information of languages (Japanese, English, and so on) installed in the target apparatus so as to be displayed. The operation unit type indicates a kind of the operation panel of the target apparatus. The operation screen displayed in the process of displaying the UI may resemble the outer appearance of the operation panel provided in the target apparatus based on the values of these items.

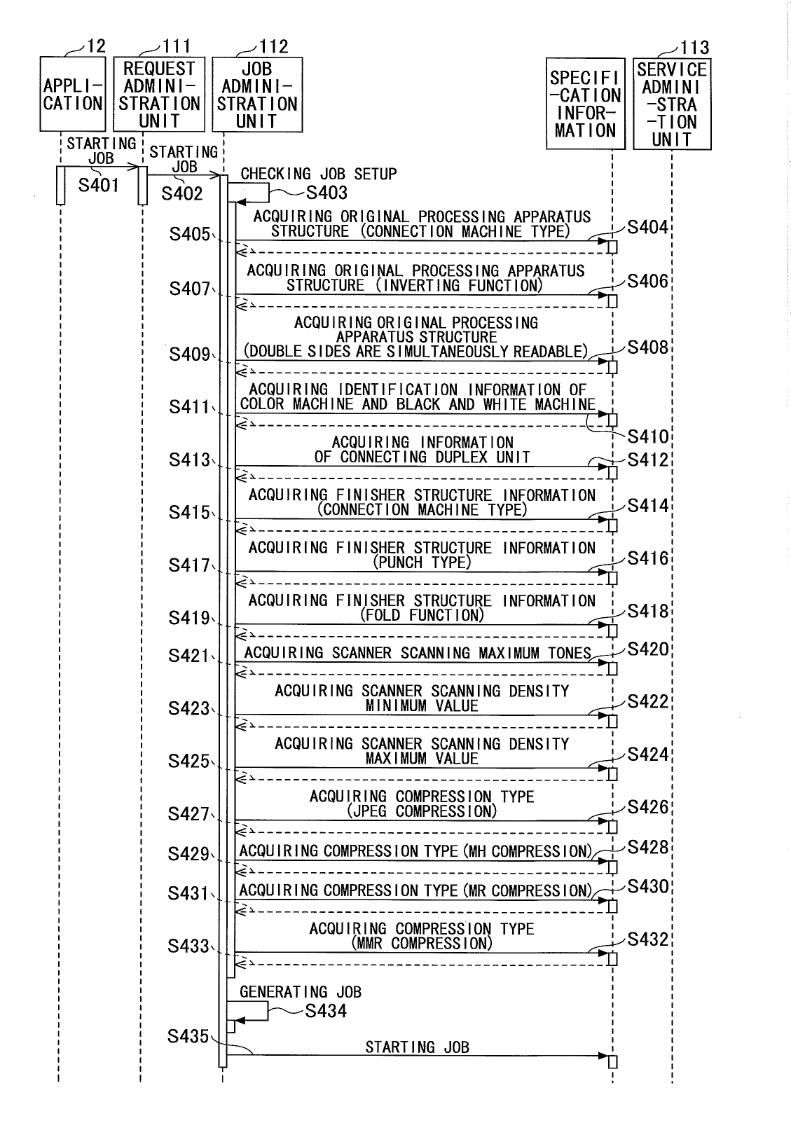

Subsequently, the step S40 of FIG. 3 is described in detail. FIG. 9 is a sequence chart for explaining an exemplary procedure of a job execution process.

In step S401, when a certain application 12 calls the API 120 related to a request to start the job, the request to start the job is input in the request administration unit 111. The request includes setup information related to the job. The request administration unit 111 reports the request to start the job to the job administration unit 112 (step S402).

Subsequently, the job administration unit 112 performs a check process of checking setup information of the job (step S403). The check process of the setup information is a process of checking whether a setup content indicative of the setup information is within a range of the specifications or the capabilities of the target apparatus or not. Said differently, the check process of the setup information determines whether setup values of the setup items forming the setup information can be set to the target apparatus.

In the check process of the setup information, out of values of items of the target specification information, the value related to the job is acquired. The job administration unit 112 can specify the target specification information out of the specification information stored the specification information memory unit 119 based on the machine number stored in the memory device 103.

Here, it is requested to start a copy job. Then, the value of the item related to the copy job is acquired from the target specification information. Referring to FIG. 9, the values of the original processing apparatus structure (connection machine type), the original processing apparatus structure (inverting function), the original processing apparatus structure (double sides are simultaneously readable), the identification information of color machine and black and white machine, the information of connecting the duplex unit, the finisher structure information (connection machine type), the finisher structure information (punch type), the finisher structure information (fold function), the scanner scanning maximum tones, the scanner scanning density minimum value, the scanner scanning density maximum value, the compression type (JPEG compression), the compression type (MH compression), the compression type (MR compression), and the compression type (MMR compression) are acquired from the target specification information, as an example.

When the content of the setup information of the job does not fit any one of the values acquired from the target specification information, the job administration unit 112 returns an execution error of the job to the request administration unit 111. The value of the unfit value of the item can be forcibly written over by a value allowable in the target specification information. When the content of the setup information of the job does not fit any one of the values acquired from the target specification information, the process may follow the operation of the image forming apparatus of the model corresponding to the model name of the target specification information.

Subsequently, the job administration unit 112 creates a job related to the request to start the job. The creation of the job is, for example, a conversion of the content of the setup information of the job to a form comprehensible by the service administration unit 113. Subsequently, the job administration unit 112 requests the service administration unit 113 to start the job (step S435).

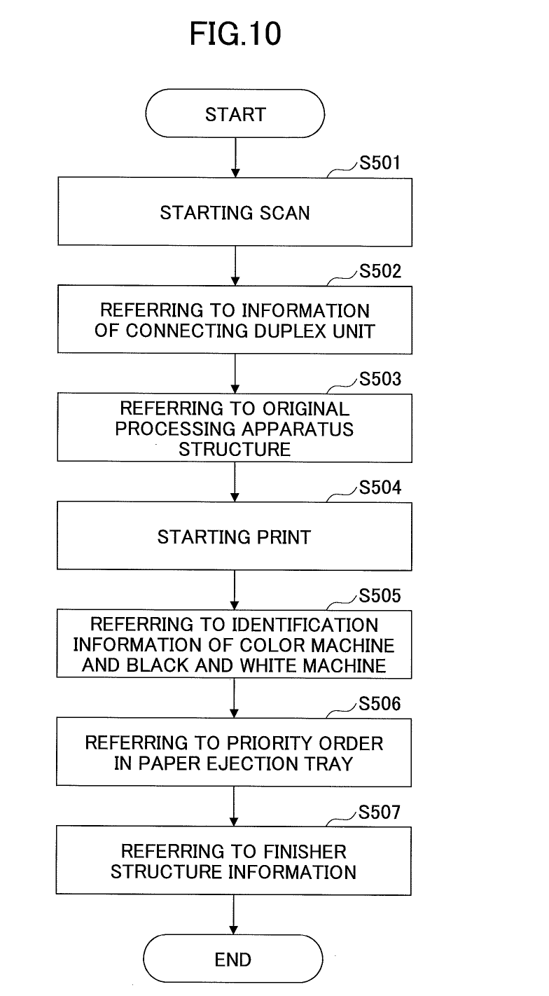

Subsequently, an example of the procedure performed by the service administration unit 113 in response to the request to start the job in step S435 is described. FIG. 10 is a flowchart for explaining an exemplary procedure performed by the service administration unit when a copy job is executed.

In step S501, the service administration unit 113 starts a virtual scan of an original. Because the information processing apparatus 10 does not have a scanner, the scan is performed in the pseudo or virtual manner, said differently an emulation of the scan is performed. While the scan is being performed, the service administration unit 113 refers to, for example, the value of the information of connecting the duplex unit and the valve of the original processing apparatus structure out of the values acquired from the target specification information in the initialization process (steps S502 and S503). Said differently, the scan in the pseudo or virtual manner is performed in response to the value of the information of connecting the duplex unit and the valve of the original processing apparatus structure. The original processing apparatus structure includes the original processing apparatus (connection machine type), the original processing apparatus structure (inverting function), and the original processing apparatus (double sides are simultaneously readable). For example, a time required for the scan may change based on these valves, or the surface to be scanned may be changed based on these values.

Subsequently, the service administration unit 113 starts a print of image data generated by the scan in the pseudo or virtual manner. Said differently, a copy is substantialized by a combination of the scan and the print. Because the information processing apparatus 10 does not have a printer, the print is performed in the pseudo or virtual manner, said differently an emulation of the print is performed. In the print process, the service administration unit 113 refers to, for example, the value of identification information of color machine and black and white machine, the value of priority order in paper ejection tray, and the value of finisher structure information out of the values of items of the target specification information. The print in the pseudo or virtual manner is performed in response to the value of identification information of color machine and black and white machine, the value of priority order in paper ejection tray, and the value of finisher structure information. For example, when the value of identification information of color machine and black and white machine indicates a black and white machine, even if a color copy is required by the setup information of the job, the copy is performed in black and white. As a result, a black toner is virtually consumed. The virtual consumption of the toner is substantialized by, for example, a change on a value of a parameter indicative of the remaining amount of the toner. When a post process is required by the setup information of the job, the post process in the pseudo or virtual manner is performed in response to the finisher structure information. The finisher structure information includes the finisher structure information (connection machine type), the finisher structure information (punch type), and the finisher structure information (fold function).

A value of an item which is not illustrated in FIG. 10 may be referred to out of the target specification information and the scan, the print, or the like may be performed.

As described, within the embodiment, the information different for each machine body or each machine type is stored in the specification information memory unit 119, and the emulation is performed based on the information. Therefore, the emulation for each machine body or each machine type can be substantialized.

Within the embodiment, although the image forming apparatus is used as an example of the apparatus, the embodiment is applicable to a projector, a video teleconference system, a digital camera, or another apparatus.

When the function of the information processing apparatus 10 is provided to an information processing apparatus such as a personal computer (PC) used by the user through a network, the UI unit 117 may send display data indicative of information related to the emulation to this information processing apparatus. The UI unit 117 may receive an input instruction or the like from this information processing apparatus.

Within the embodiment, the information processing apparatus 10 is an example of an information processing system. The specification information memory unit 119 is an example of a memory unit. The emulation unit 11 is an example of an imitation unit. The setup receipt unit 118 is an example of a receipt unit.

Thus, the emulation for each machine body or each machine type can be substantialized.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority or inferiority of the invention. Although an information processing apparatus has been described in detail, it should be understood that various changes, substitutions, and alterations could be made thereto without departing from the spirit and scope of the invention.

This application is based upon and claims the benefit of priority of the prior Japanese Patent Application No. 2013-266435, filed on Dec. 25, 2013, the entire contents of which are incorporated herein by reference.

What is claimed is:

1. An information processing apparatus comprising:
a memory unit that stores information of each of machine bodies of apparatuses or each of machine types of the apparatuses in association with identification information of each of the machine bodies or each of the machine types;
a receipt unit that receives a designation of the identification information of the machine body, which is a target of emulation, or the machine type, which is the target of the emulation; and
an imitation unit that imitates an operation of a first apparatus among said apparatuses based on the information stored in the memory unit and corresponding to the identification information, of which designation is received by the receipt unit, when a request is received from an application program corresponding to the first apparatus.

2. The information processing apparatus according to claim 1,
wherein the information of each of the machine bodies or each of the machine types relates to performances of the apparatuses or specifications of the apparatuses.

3. The information processing apparatus according to claim 1,
wherein the imitation unit changes a process related to a job performed by the first apparatus in conformity with the information stored in the memory unit.

4. A method of processing information, the method being performed by at least one computer, the method comprising:
receiving a designation of identification information of a machine body of an apparatus, which is a target of emulation, or a machine type of the apparatus, which is the target of the emulation;
imitating an operation of the apparatus based on information of each of machine bodies of apparatuses including the apparatus or each of machine types of the apparatuses in association with identification information of each of the machine bodies or each of the machine types, the information being stored in the memory unit and corresponding to the identification information, of which designation is received by the receipt unit, when a request is received from an application program corresponding to the apparatus; and
displaying imitation information related to imitation of the operation of the apparatus in the imitating on an information processing apparatus connected to the at least one computer through a network.

5. The method of processing information according to claim 4,
wherein the information of each of the machine bodies or each of the machine types relates to performances of the apparatuses or specifications of the apparatuses.

6. The method of processing information according to claim 4,
wherein the imitation unit changes a process related to a job performed by the apparatus in conformity with the information stored in the memory unit.

7. A computer program product for being executed on a computer to perform a method, the method comprising:
receiving a designation of identification information of a machine body of an apparatus, which is a target of emulation, or a machine type of the apparatus, which is the target of the emulation; and
imitating an operation of the apparatus based on information of each of machine bodies of apparatuses including the apparatus or each of machine types of the apparatuses in association with identification information of each of the machine bodies or each of the machine types, the information being stored in the memory unit and corresponding to the identification information, of which designation is received by the receipt unit, when a request is received from an application program corresponding to the apparatus

8. The computer program product according to claim 7,
wherein the information of each of the machine bodies or each of the machine types relates to performances of the apparatuses or specifications of the apparatuses.

9. The computer program product according to claim 7,
wherein the imitation unit changes a process related to a job performed by the apparatus in conformity with the information stored in the memory unit.
